(19) United States
(12) Patent Application Publication
(10) Pub. No.: US 2013/0247049 A1
(43) Pub. Date: Sep. 19, 2013

(54) CONTROL APPARATUS AND METHOD OF STARTING CONTROL APPARATUS

(71) Applicants: Satoshi Aoki, Kanagawa (JP); Naoya Morita, Kanagawa (JP); Naoya Ohashi, Kanagawa (JP); Tamon Sadasue, Kanagawa (JP); Satoshi Mori, Tokyo (JP)

(72) Inventors: Satoshi Aoki, Kanagawa (JP); Naoya Morita, Kanagawa (JP); Naoya Ohashi, Kanagawa (JP); Tamon Sadasue, Kanagawa (JP); Satoshi Mori, Tokyo (JP)

(73) Assignee: RICOH COMPANY, LTD., Tokyo (JP)

(21) Appl. No.: 13/782,347

(22) Filed: Mar. 1, 2013

(30) Foreign Application Priority Data
Mar. 13, 2012 (JP) 2012-056195

(51) Int. Cl. G06F 9/44

(52) U.S. Cl. CPC G06F 9/44
USPC 718/100

(57) ABSTRACT

A control apparatus may include a processor configured to execute one or more programs in order to control a control target, and an accepting unit configured to accept a user input. The processor may start a first program to cause the accepting unit to function at a time of starting the control apparatus, and thereafter start a second program for executing a function selected by the user input accepted by the accepting unit, amongst a plurality of functions executable by the control target, with preference over programs for executing other functions.

### CROSS-REFERENCE TO RELATED APPLICATIONS

This application is based upon and claims the benefit of priority of Japanese Patent Application No. 2012-056195, filed on Mar. 13, 2012, the entire contents of which are incorporated herein by reference.

### BACKGROUND OF THE INVENTION

1. Field of the Invention

The present invention generally relates to a control apparatus to control an apparatus that is a control target, and to a method of starting such a control apparatus.

2. Description of the Related Art

Conventionally, proposals have been made to increase the start (or boot) speed of an information processing apparatus. Particularly in the case of an MFP (Multi-Function Peripheral) and an embedded computer that is embedded in a projector and the like, a user may desire to utilize various functions immediately after the power is turned ON. For this reason, there are demands to increase the start speed of the information processing apparatus.

However, as the scale of the information processing apparatus becomes larger, it may take more time to read all of an OS (Operating System) or kernel, middleware, application, and the like from a program memory to a RAM (Random Access Memory), and the start time may tend to increase. As a result, the user needs to wait until all of the programs are read from the program memory to the RAM.

For example, Japanese Laid-Open Patent Publication No. 2011-151806 proposes an image processing apparatus having a plurality of functions. This proposed image processing apparatus stores the functions to be started with preference over others, for each user information. When the power is turned ON or when resuming an original state from a power save state, the user is urged to input the user information. This proposed image processing apparatus performs a control in order to read and start a program for executing a function that is to be started with preference and corresponds to the input user information, before other programs.

However, when the user desires to first utilize a certain function other than the functions stored within the proposed image processing apparatus at the time of starting the proposed image processing apparatus, the start of the certain program cannot be advanced or quickened.

### SUMMARY OF THE INVENTION

Accordingly, it is a general object in one embodiment of the present invention to provide a novel and useful control apparatus and method of starting the control apparatus, in which the problem described above may be suppressed.

Another and more specific object in one embodiment of the present invention is to provide a control apparatus and a method of controlling the control apparatus, which may start a function desired by a user with preference over other functions, in order to improve the utilization ease or convenience to the user.

According to one aspect of the present invention, a control apparatus may include a processor configured to execute one or more programs in order to control a control target; and an accepting unit configured to accept a user input, wherein the processor starts a first program to cause the accepting unit to function at a time of starting the control apparatus, and thereafter starts a second program for executing a function selected by the user input accepted by the accepting unit, amongst a plurality of functions executable by the control target, with preference over programs for executing other functions.

Other objects and further features of the present invention will be apparent from the following detailed description when read in conjunction with the accompanying drawings.

### BRIEF DESCRIPTION OF THE DRAWINGS

FIG. 1 is a diagram illustrating an example of a hardware structure of a system formed by a plurality of image forming apparatuses and the like in one embodiment of the present invention;

FIG. 2 is a diagram illustrating an example of a hardware structure of the image forming apparatus;

FIG. 3 is a diagram illustrating an example of a hardware structure of a SoC (System on Chip);

FIG. 4 is a diagram for explaining a technique for performing inter-core communication;

FIG. 5 is a diagram illustrating an example of software hierarchical layers executed by each core;

FIG. 6 is a diagram illustrating an example of a functional structure of the image forming apparatus in one embodiment;

FIG. 7 is a sequence diagram for explaining an example of a process that may be executed at the time of starting the image forming apparatus;

FIG. 8 is a diagram illustrating an example of transitions of screens displayed on an operation unit at the time of starting the image forming apparatus;

FIG. 9 is a sequence diagram for explaining another example of the process that may be executed at the time of starting of the image forming apparatus;

FIG. 10 is a diagram illustrating another example of the transitions of the screens displayed on the operation unit at the time of starting the image forming apparatus;

FIG. 11 is a diagram illustrating an example of apparatus coordinating information related to other image forming apparatuses coordinated with the image forming apparatus;

FIG. 12 is a diagram schematically illustrating results of learning a degree of association of functions; and

FIG. 13 is a sequence diagram for explaining an example of a function exchange of the image forming apparatus with the other image forming apparatuses.

### DESCRIPTION OF THE PREFERRED EMBODIMENTS

A description will be given of embodiments of the control apparatus and the method of starting the control apparatus according to the present invention, by referring to the drawings.

An image forming apparatus and a system in one embodiment of the present invention will be described hereunder.

[Hardware Structure, Etc.]

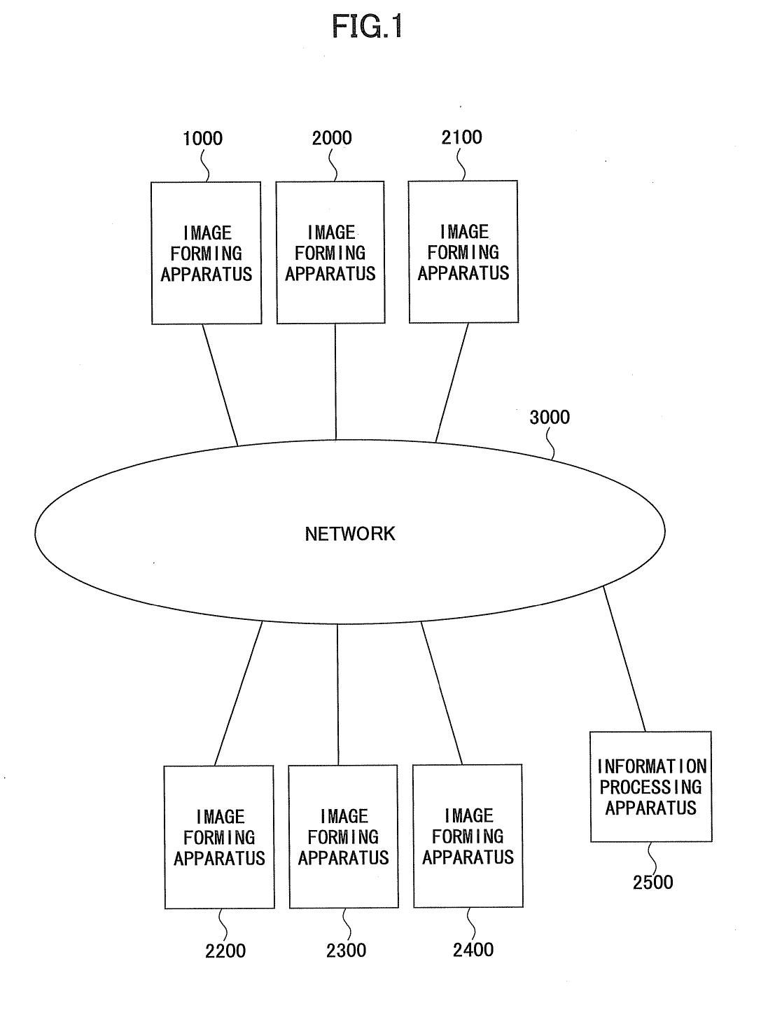

FIG. 1 is a diagram illustrating an example of a hardware structure of a system formed by a plurality of image forming apparatuses and the like in one embodiment of the present invention. The system illustrated in FIG. 1 may include image forming apparatuses 1000, 2000, 2100, 2200, 2300, and 2400, and an information processing apparatus 2500 that are connected via a network 3000. The network 3000 may be formed by a WAN (Wide Area Network), a LAN (Local Area Network), and the like. The network 3000 may include a cable network, a wireless network, or a combination of cable and wireless networks.

Each of the image forming apparatuses 1000, 2000, 2100, 2200, 2300, and 2400 may be formed by a MFP that includes a copy function, a print function, a facsimile function, a scan function, and the like. In addition, the image forming apparatuses 1000, 2000, 2100, 2200, 2300, and 2400 may share information via the network 3000, in order to mutually coordinate (or link) each of the functions thereof.

The information processing apparatus 2500 may instruct various function settings with respect to each of the image forming apparatuses 1000, 2000, 2100, 2200, 2300, and 2400, may perform remote operations, and may monitor a state of the network 300. More particularly, the information processing apparatus 2500 may instruct the function to be started with preference (or priority) at the time of the starting, with respect to each of the image forming apparatuses 1000, 2000, 2100, 2200, 2300, and 2400, and may instruct printing of contents of a desired file. FIG. 1 illustrates only one information processing apparatus 2500, however, a plurality of information processing apparatuses 2500 may be connected to the network 3000.

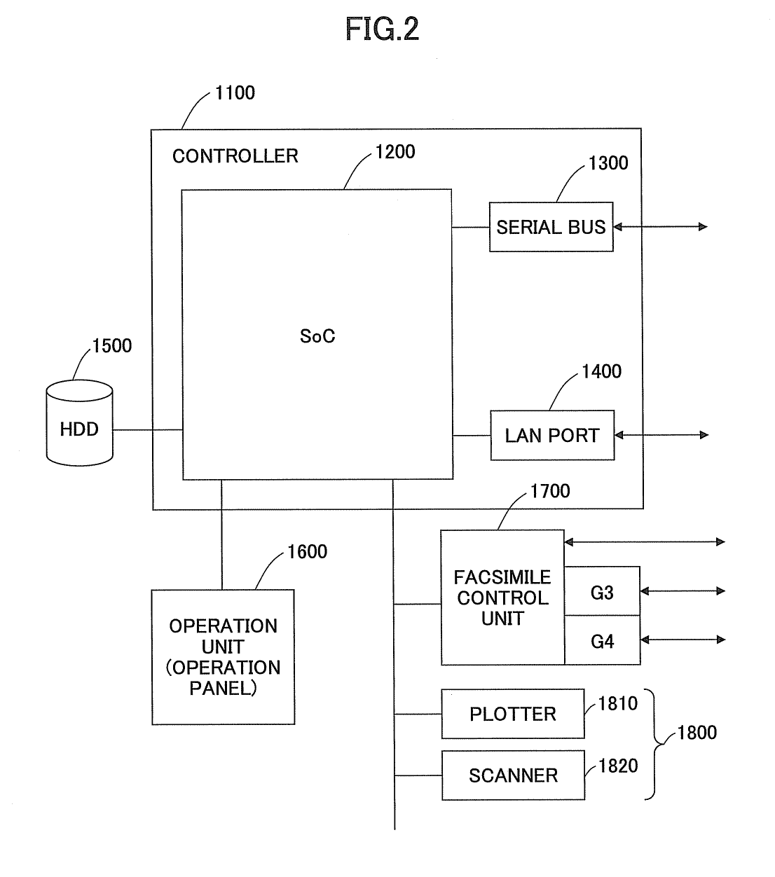

FIG. 2 is a diagram illustrating an example of a hardware structure of the image forming apparatus 1000. The image forming apparatus 1000 may include a controller 1100, a HDD (Hard Disk Drive) 1500, an operation unit (or operation panel) 1600, a facsimile control unit 1700, and an engine unit 1800. For example, the controller 1100 may include a SoC (System on Chip) 1200, a serial bus 1300, and a LAN port 1400.

The SoC 1200 may include hardware, such as a CPU (Central Processing Unit), a memory, a bus connecting the CPU and the memory, and the like, that are mounted on a single chip. The serial bus 1300 may connect the SoC 1200 to a PCI (Peripheral Component Interconnect) device, a peripheral device, and the like. The LAN port 1400 may connect the SoC 1200 to the network 3000.

The HDD 1500 may store image data, one or more programs, font data, firmware, and the like.

The operation unit 1600 may include a display and buttons, a touchscreen panel, or the like. The operation unit 1600 may accept an input operation made by the user, and may display various screens in order to provide information with respect to the user.

The facsimile control unit 1700 may include hardware for controlling facsimile communications. The engine unit 1800 may include a plotter 1810 that is an example of hardware for making a printed output, and a scanner 1820 that is an example of hardware for making a scanner input. Since the hardware included in the engine unit 1800 is known, a description thereof will be omitted.

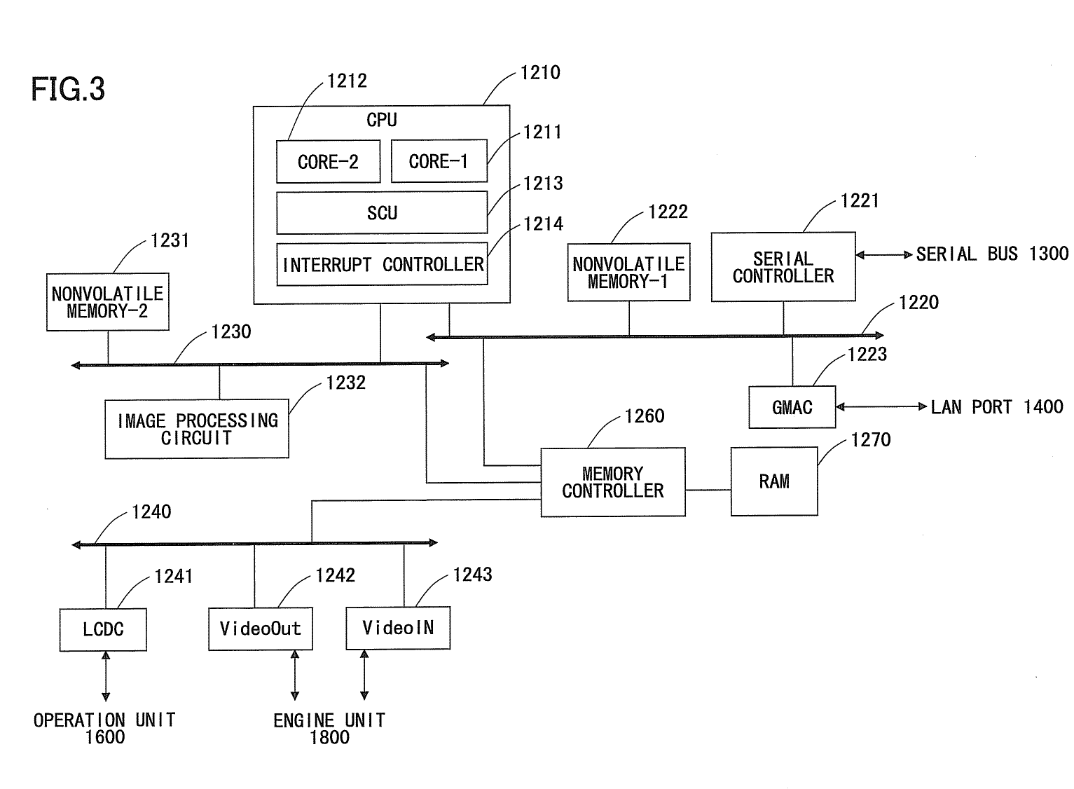

FIG. 3 is a diagram illustrating an example of a hardware structure of the SoC 1200. The SoC 1200 may include a CPU 1210. For example, the CPU 1210 may be formed by a multi-core CPU. In this case, the CPU 1210 may include a core-1 1211, a core-2 1212, a SCU (Snoop Control Unit) 1213, and an interrupt controller 1214. Each of the core-1 1211 and the core-2 1212 may be formed by a processor including a program counter, an instruction decoder, various computing units (or operation units), an LSU (Load Store Unit), a general-purpose register, a cache memory, and the like. The SCU 1213 may maintain consistency of the cache memories of the core-1 1211 and the core-2 1212.

In this embodiment, the core-1 1211 may execute interactive functions between users or between apparatuses, such as a UI (User Interface), communication, and the like. On the other hand, the core-2 1212 may control the functions of the image forming apparatus 1000, such as the copy function, the print function, the facsimile function, the scan function, and the like. The interrupt controller 1214 may control an inter-core interrupt, accept an external interrupt signal, and the like.

The SoC 1200 may include, as hardware to be mainly utilized by the core-1 1211, a bus-1 1220, a serial controller 1221, a nonvolatile memory-1 1222, and a GMAC (Gigabit Ethernet Media Access Controller) 1223. For example, the nonvolatile memory-1 1222 may be formed by an EEPROM (Electrically Erasable Programmable Read Only Memory), a flash memory, and the like, and may store an OS (or kernel), an application program, and the like of the core-1 1211. The nonvolatile memory-1 1222 may include a mask ROM (Read Only Memory). The bus-1 1220 may form a transfer path for the data and address, provided exclusively for processes of the core-1 1211. The core-1 1211 may read the OS and application program from the nonvolatile memory-1 1222 via the bus-1 1220, and load the read OS and application program to a RAM (Random Access Memory) 1270 in order to start the OS and the application program. The serial controller 1221 may be connected to the serial bus 1300, and control the PCI device, the peripheral device, and the like. The GMAC 1223 may be connected to the LAN port 1400, and form a communication controller to control communications with other image forming apparatuses or the information processing apparatus 2500 via the network 3000. The core-1 1211 may cooperate with other image forming apparatuses via the GMAC 1223.

In addition, the SoC 1200 may include, as hardware to be mainly utilized by the core-2 1212, a bus-2 1230, a nonvolatile memory-2 1231, and an image processing circuit 1232. For example, the nonvolatile memory-2 1231 may be formed by an EEPROM, a flash memory, and the like, and may store an OS (or kernel), an application program, and the like of the core-2 1212. The nonvolatile memory-2 1231 may include a mask ROM. The bus-2 1230 may form a transfer path for the data and address, provided exclusively for processes of the core-2 1212. The core-2 1212 may read the OS and application program from the nonvolatile memory-2 1231 via the bus-2 1230, and load the read OS and application program to the RAM 1270 in order to start the OS and the application program. The image processing circuit 1232 may form a circuit dedicated to executing a copy application, a print application, and the like at a high speed.

Furthermore, the SoC 1200 may include, as hardware to be shared by the core-1 1211 and the core-2 1212, a memory controller 1260 and the RAM 1270. The memory controller 1260 may arbitrate access requests, such as read, write, and the like with respect to the RAM 1270. The RAM 1270 may be utilized as a plotting memory of the image forming apparatus 1000, a data storage region for the data shared between the core-1 1211 and the core-2 1212, a temporary data storage region for the application program, and the like. An LCDC (Liquid Crystal Display Controller) 1241, a Video Out 1242, and a Video IN 1243 may be connected to the memory controller 1260 via a bus-3 1240. The bus-3 1240 may provide a transfer path for the data input and output between the SoC 1200 and each of the operation unit 1600 and the engine unit 1800. The LCDC 1241 may form a hardware circuit to control a video signal output to the operation unit 1600. The Video Out 1242 and the Video IN 1243 may form hardware circuits to output image information to the plotter 1810 and to input image information from the scanner 1820.

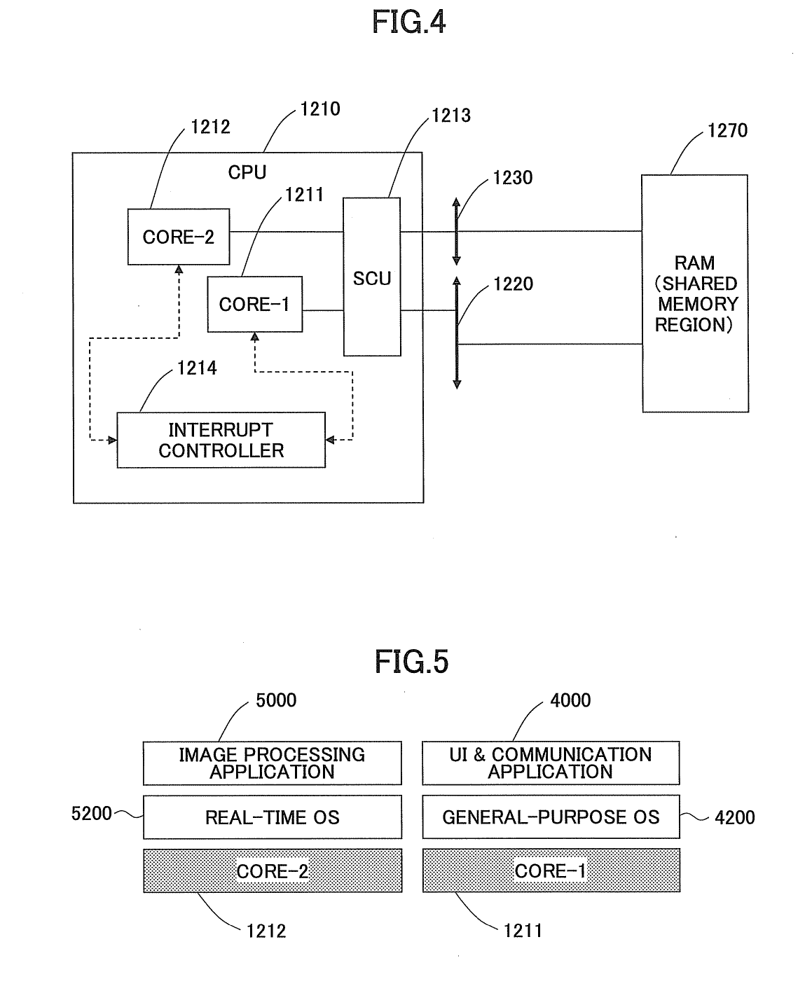

FIG. 4 is a diagram for explaining a technique for performing inter-core communication. When sending instruction and data from the core-1 1211 to the core-2 1212, the core-1 1211 may write the instruction and data to be sent in a shared memory region of the RAM 1270, and send an interrupt signal with respect to the interrupt controller 1213. The interrupt controller 1213 may transfer the interrupt signal from the core-1 1211 to the core-2 1212. The core-2 1212 may read the instruction and data from the shared memory region of the RAM 1270 in response to receiving the interrupt signal from the core-1 1211, in order to receive the instruction and data sent from the core-1 1211. The communication from the core-2 1212 to the core-1 1211 may be performed in a similar manner to the communication from the core-1 1211 to the core-2 1212.

FIG. 5 is a diagram illustrating an example of software hierarchical layers executed by each core. As illustrated in FIG. 5, a general-purpose OS 4200, such as ANDROID (registered trademark), LINUX (registered trademark), and the like, may be installed in the core-1 1211. An UI and communication application 4000 may run in the general-purpose OS 4200. On the other hand, a real-time OS 5200, such as ITRON (registered trademark), and the like, may be installed in the core-2 1212. An image processing application 5000 may run in the real-time OS 5200. The above described types of OS installed in each of the core-1 1211 and the core-2 1212 are merely examples, and the types of OS are not limited to the described types.

[Functional Structure]

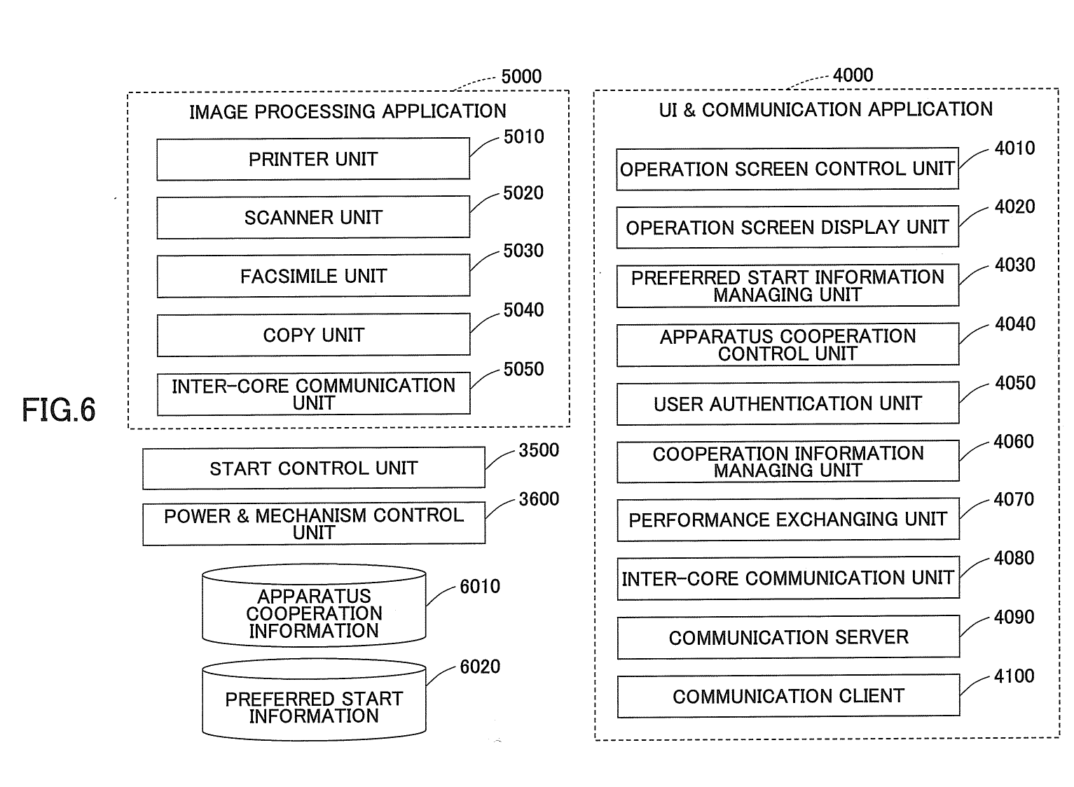

FIG. 6 is a diagram illustrating an example of a functional structure of the image forming apparatus 1000 in one embodiment. As illustrated in FIG. 6, the image forming apparatus 1000 may include a start control unit 3500, a power and mechanism control unit 3600, various function units that function when the UI and communication application 4000 is executed, and various function units that function when the image processing application 5000 is executed. Each of the various function units may operate by referring to apparatus cooperation information 6010 and preferred start information 6020 stored in the HDD 1500.

The start control unit 3500 may control initialization of devices, and loading of the OS and the application. The power and mechanism control unit 3600 may control power supply and the like to each part of the image forming apparatus 1000.

For example, the function units that function when the UI and communication application 4000 is executed may include an operation screen control unit 4010, an operation screen display unit 4020, a preferred start information managing unit 4030, an apparatus cooperation control unit 4040, a user authentication unit 4050, a cooperation information managing unit 4060, a performance exchanging unit 4070, an inter-core communication unit 4080, a communication server 4090, and a communication client 4100.

The operation screen control unit 1410 may control a screen transition in response to an action event, such as pushing of a button by the user, in order to request the operation screen display unit 4020 to make a display on the operation unit 1600. The operation screen display unit 4020 may display a screen on the operation unit 1600 in response to receiving the request from the operation screen control unit 4010.

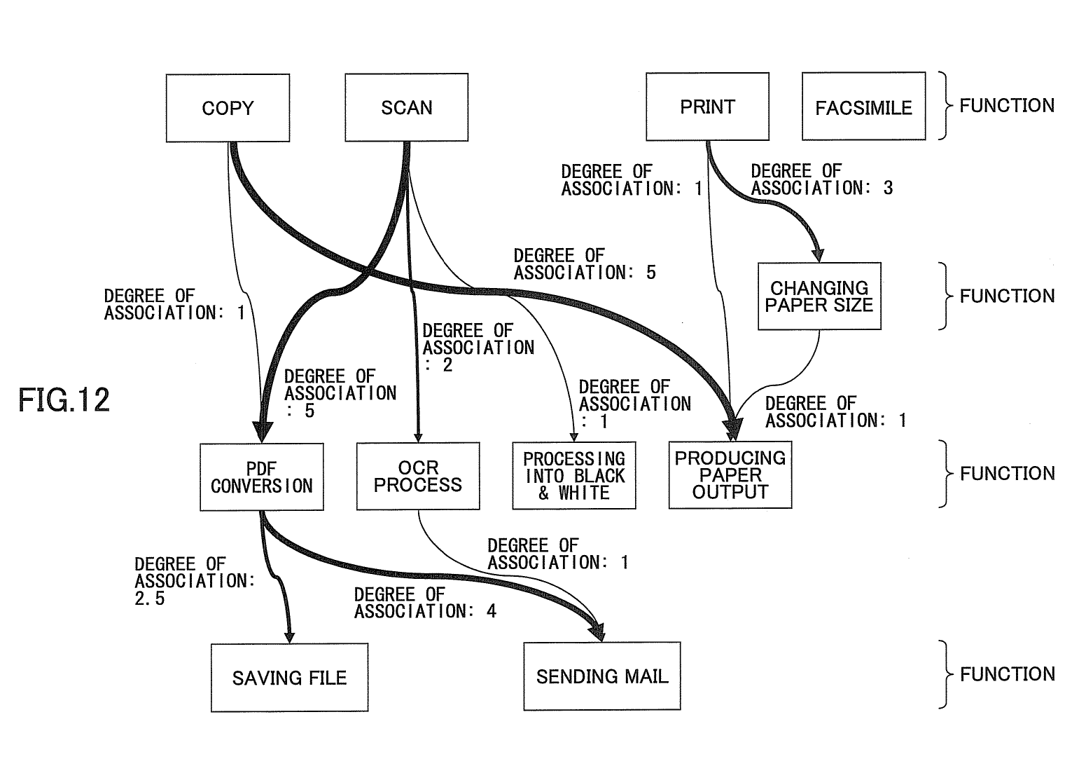

The preferred start information managing unit 4030 may store a degree of association between the function to be started with preference and other functions. The degree of association will be described later in conjunction with FIG. 12, and the function to be started with preference will also be described later. The preferred start information managing unit 4030 manages the preferred start information 6020 for reading, with preference, the program having a high possibility of being used together with the function specified by the user. For example, the preferred start information 6020 may include two kinds of information, namely, information computed from usage log of all users utilizing the image forming apparatus 1000, and preferred start information computed from the usage log of each user. In a case in which a user authentication is performed at the time of starting the image forming apparatus 1000, the preferred start information computed from the usage log of each user may be used.

Based on the function and the cooperating destination selected by the user from the operation screen control unit 4010, the apparatus cooperation control unit 4040 may send a request to execute the specified function with respect to the cooperating destination, via the communication client 4100.

The user authentication unit 4050 may execute the user authentication. When the user authentication is executed, the start control unit 3500 and the operation screen control unit 4010 may be notified of an authentication result. In a case in which the user authentication is successful, the start control unit 3500 may acquire the preferred start information computed from the usage log of each user, from the preferred start information managing unit 4030, in order to execute a preferred start (or preferred boot).

The cooperation information managing unit 4060 may manage the apparatus cooperation information 6010, as will be described later in more detailed.

The performance exchanging unit 4070 may form a function unit to exchange in advance the information required for the cooperation between the apparatuses. It is assumed for the sake of convenience that the performance exchange may be executed periodically at timings specified by the user. Information that is exchanged may include a state of the apparatus, a list of usable functions, a communication time, and the like. When the cooperation is to be made within the same network, a performance exchange request may be broadcast, so that the performance exchange request may be detected automatically and set to the cooperating destination, without requiring the user to specify the cooperating destination.

The inter-core communication unit 4080 may control the write to the shared memory region of the RAM 1270, the generation of the interrupt signal, and the like, in order to communicate with the core-2 1212.

The communication server 4090 may accept a request to execute a function (hereinafter also referred to as “function execution request”) from another image forming apparatus. When the function execution request is accepted, the apparatus cooperation control unit 4040 may judge whether the requested function is executable. The corresponding application may be executed when the judgment result indicates that the requested function is executable, and the communication server 4090 may send the execution result to the other image forming apparatus.

The communication client 4100 may send a function execution request with respect to another image forming apparatus. The apparatus cooperation control unit 4040 may be notified of the communication result, and the communication result may be displayed on the operation unit 1600 via the operation screen control unit 4010 and the operation screen display unit 4020.

On the other hand, the function part that functions when the image processing application 5000 is executed may include a printer unit 5010, a scanner unit 5020, a facsimile unit 5030, a copy unit 5040, and an inter-core communication unit 5050. The printer unit 5010, the scanner unit 5020, the facsimile unit 5030, and the copy unit 5040 may perform a control to execute the print function, the scan function, the facsimile function, and the copy function of the image forming apparatus 1000, respectively. The inter-core communication unit 5050 may control the write to the shared memory region of the RAM 1270, the generation of the interrupt signal, and the like, in order to communicate with the core-1 1211.

[Process at Time of Starting]

Next, a description will be given of the process at the time of starting the image forming apparatus. The time of starting the image forming apparatus may include the time when the power is turned ON, the time when the original state is resumed from a dormant state, and the like. In the following description, it is assumed for the sake of convenience that the time of starting the image forming apparatus is the time when the power is turned ON.

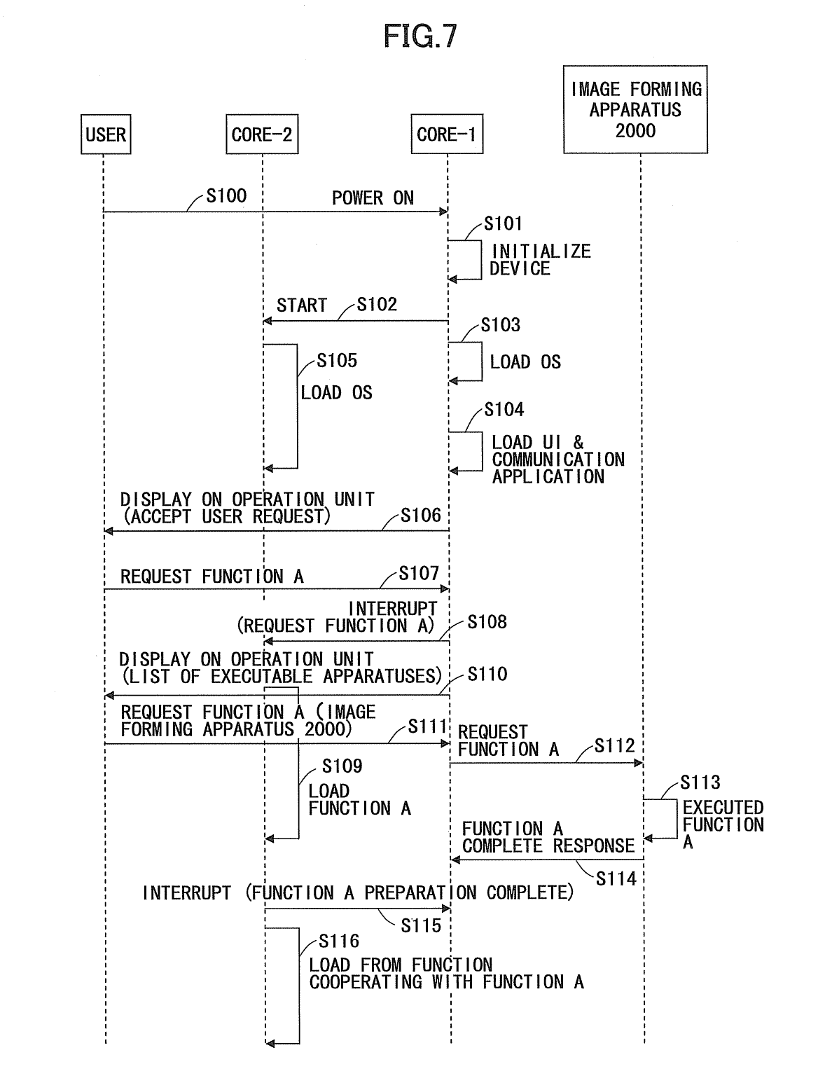

FIG. 7 is a sequence diagram for explaining an example of a process that may be executed at the time of starting the image forming apparatus 1000.

First, when the user operates a power switch to turn the power ON, the hardware of the core-1 1211 is started (step S100).

The core-1 1211 initializes hardware devices, such as the memory controller 1260, the image processing circuit 1232, and the like (step S101).

Next, the core-1 1211 starts the core-2 1212 (step S102). Then, the core-1 1211 loads the general-purpose OS 4200 (step S103), and loads the UI and communication application 4000 (step S104). On the other hand, the core-2 1212 loads the real-time OS 5200 (step S105).

When the loading of the UI and communication application 4000 is completed, the core-1 1211 displays a user request accepting screen on the operation unit 1600 (step S106).

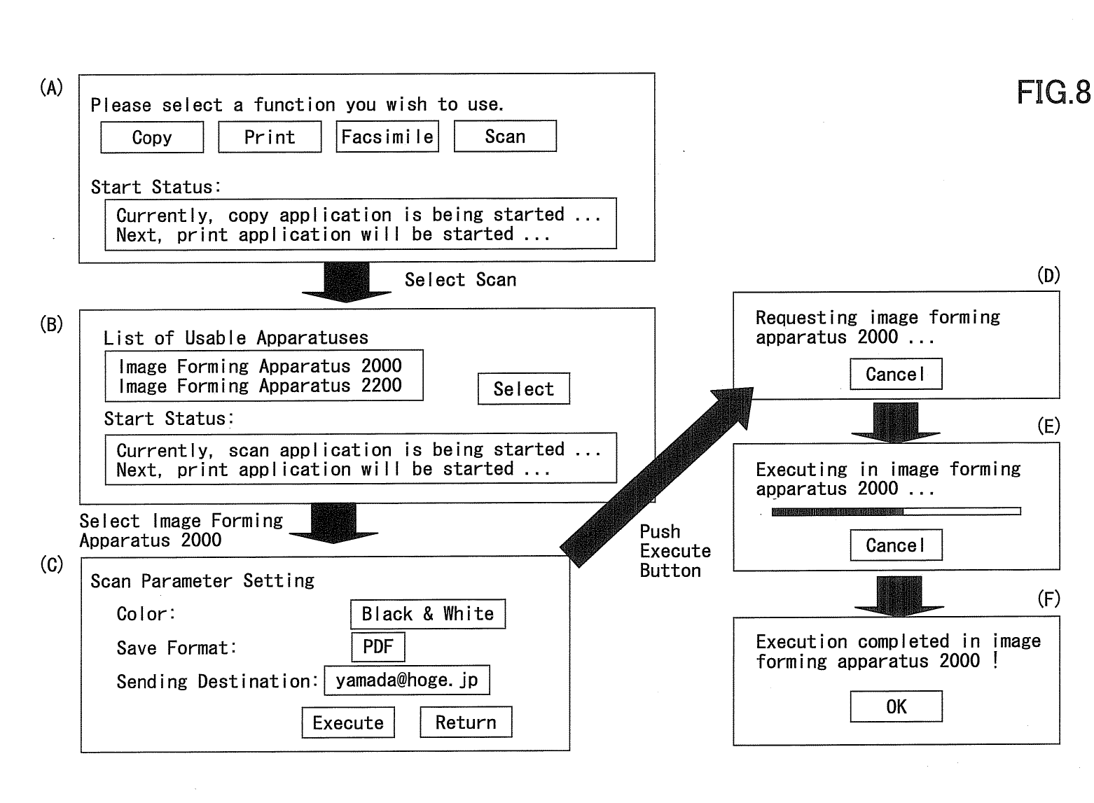

FIG. 8 is a diagram illustrating an example of transitions of screens displayed on the operation unit 1600 at the time of starting the image forming apparatus 1000. In FIG. 8, (A) illustrates an example of the user request accepting screen displayed by the process of step S106. The user request accepting screen is displayed when the loading of the UI and communication application 4000 is completed and the user request may be accepted. A button is arranged on the user request accepting screen for each of the four functions, namely, the copy, print, facsimile, and print functions, and a current start status is indicated below the four buttons.

It is assumed in this example that the user selects a function A, namely, the scan function in FIG. 8 (step S107). In this case, the core-1 1211 sends an interrupt signal instructing the preferred start of the function A, with respect to the core-2 1212 (step S108). The core-2 1212 loads the program for executing the function in response to the interrupt signal, with preference over other programs (step S109).

Next, the core-1 1211 displays on the operation unit 1600 an executable apparatus list screen that indicates the image forming apparatuses that may execute the selected function A (step S110).

In FIG. 8, (B) illustrates an example of the executable apparatus list screen displayed on the operation unit 1600 by the process of step S110. The executable apparatus list screen displays the name of each image forming apparatus capable of executing the selected function A and the start status thereof, amongst the other image forming apparatuses (at the cooperating destination) cooperating with the image forming apparatus 1000. In addition, the executable apparatus list screen may display, in addition to the name of each usable (or executable) image forming apparatus, the communication time, the usable function, and the like.

It is assumed in this example that the user selects the image forming apparatus 2000 from the executable apparatus list screen illustrated in (B) of FIG. 8 (step S111). In FIG. 8, (C) illustrates an example of an execution request accepting screen displayed on the operation unit 1600 when the user selects the image forming apparatus 2000. Parameters of the function A, namely, the scan function, may be set from the execution request accepting screen. The user may specify the color, the file format to be saved, the destination where the scanned information is to be sent, and the like from the execution request accepting screen, and push an execute (or submit) button. The user may push a return button when changing the image forming apparatus that is to execute the scan function, when not performing the scan function, and the like.

When the process described above is performed and the execution request is accepted, the core-1 1211 sends an execution request requesting execution of the function A to the image forming apparatus 2000 (step S112). In FIG. 8, (D) illustrates an example of a screen displayed on the operation unit 1600 when the core-1 1211 sends the execution request for the function A to the image forming apparatus 2000. The user may push a cancel button on the screen illustrated in (D) of FIG. 8 when the execution of the function A is to be discontinued.

The image forming apparatus 2000 executes the function A in response to the received execution request for the function A (step S113). While the image forming apparatus 2000 executes the function A, a screen illustrated in (E) of FIG. 8 is displayed on the operation unit 1600. The user may push a cancel button on the screen illustrated in (E) of FIG. 8 when the execution of the function A is to be discontinued. When the execution of the function A is completed, the image forming apparatus 2000 sends an execution complete response to the core-1 1211 (step S114). The core-1 1211 displays a screen illustrated in (F) of FIG. 8 on the operation unit 1600 when the core-1 1211 receives the execution complete response. The user may notify the image forming apparatus 1000 that the process completion is confirmed, by pushing an OK button on the screen illustrated in (F) of FIG. 8. On the other hand, when the execution of the function A fails, the core-1 1211 may again display the executable apparatus list screen on the operation unit 1600.

When the function A is executable in the image forming apparatus 2000 by making the data transfer from the image forming apparatus 1000 to the image forming apparatus 2000, the execution of the function is automatically transferred to the image forming apparatus 2000. However, in the case of a process that requires the user to perform a manual operation in the image forming apparatus, such as copying from a paper document, the process of step S112 may request that the image forming apparatus 2000 assume a state in which the function A is executable, and in this case, the user may go to the setup location of the image forming apparatus 2000 to perform the manual operation.

When the loading of the program for executing the function A is completed and the function A becomes executable, the core-2 1212 notifies the core-1 1211 by an interrupt signal that the function A is executable (step S115). Thereafter, the core-2 1212 starts a function having a high degree of association to the function A, with preference over other functions (step S116). The function having the high degree of association to another function will be described later.

[Other Processes at Time of Starting]

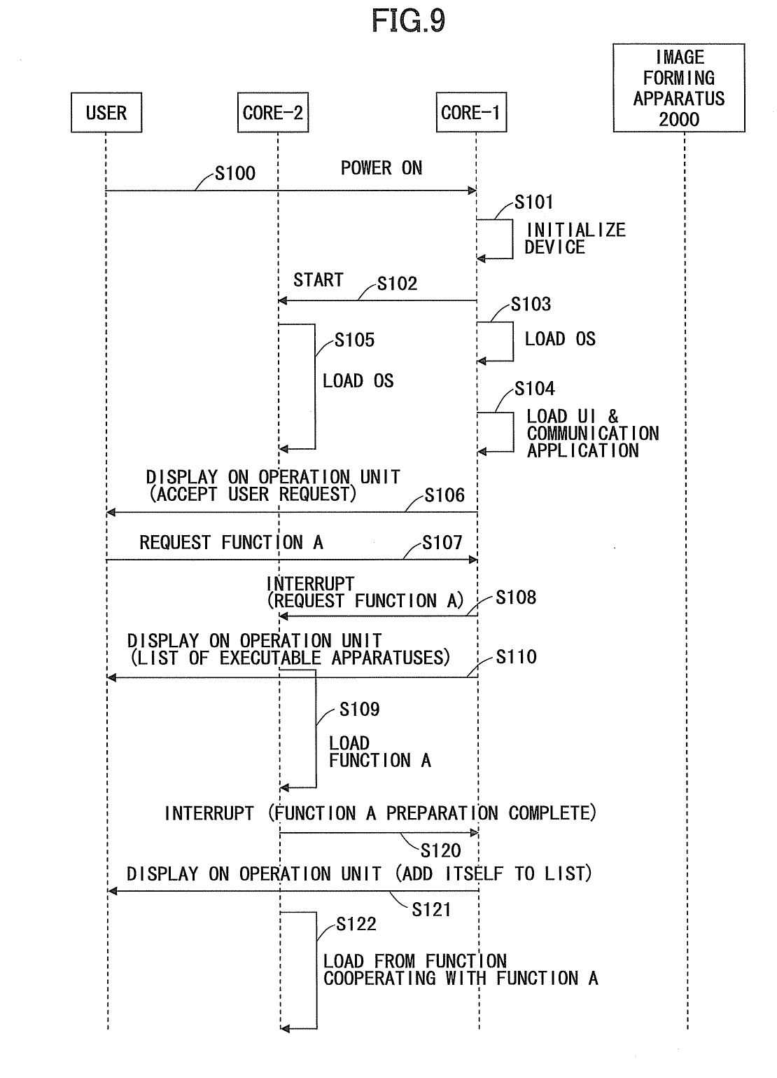

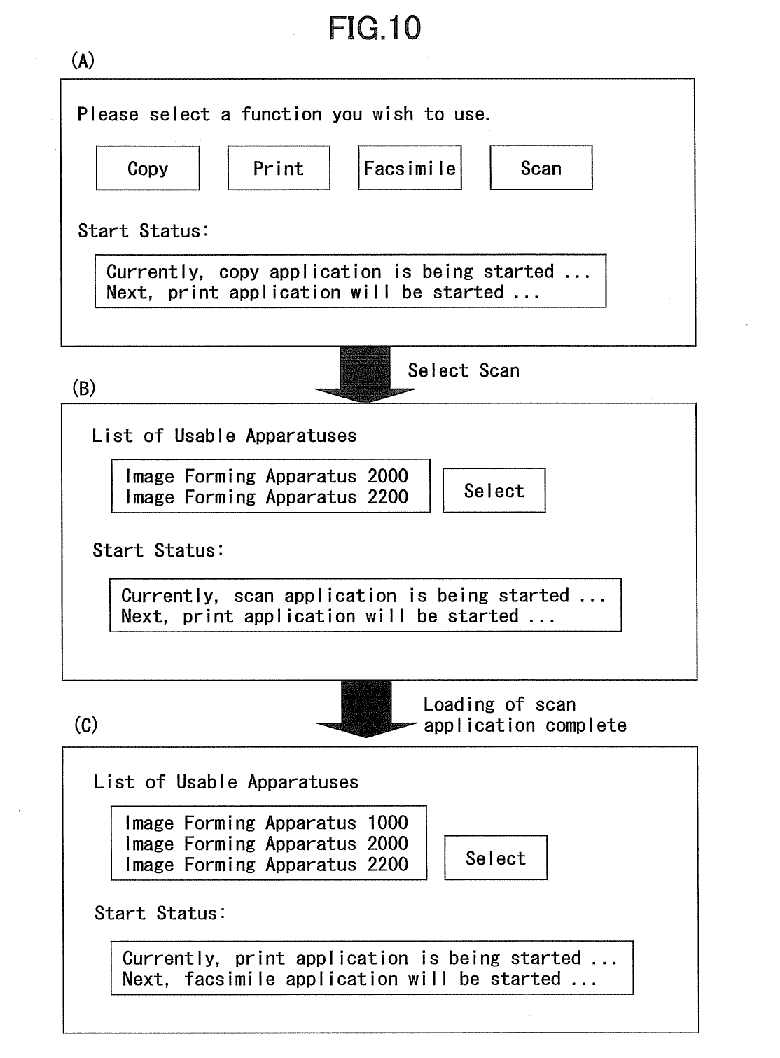

In a case in which the user does not select another image forming apparatus from the executable apparatus list screen, or in a case in which the image forming apparatus at the coordinating destination is not registered, the process becomes different from that illustrated in FIG. 7. FIG. 9 is a sequence diagram for explaining another example of the process that may be executed at the time of starting the image forming apparatus 1000. In addition, FIG. 10 is a diagram illustrating another example of the transitions of the screens displayed on the operation unit 1600 at the time of starting the image forming apparatus 1000.

In FIG. 9, the process of steps S100 to S110 are the same as that illustrated in FIG. 7, and a description thereof will be omitted. In FIG. 10, (A) illustrates an example of a user request accepting screen displayed on the operation unit 1600 by the process of step S106. In FIG. 10, (B) illustrates an example of an executable apparatus list screen displayed on the operation unit 1600 by the process of step S110.

When the user does not select the image forming apparatus 2000 and the core-2 1212 completes the loading of the program for executing the function A so that the function A is executable, the core-2 1212 notifies the core-1 1211 by an interrupt signal that the function A is executable (step S120). In this case, the core-1 1211 adds the image forming apparatus 1000 to which the core-1 1211 belongs to the list of executable apparatuses, and displays the updated executable apparatus list screen on the operation unit 1600 (step S121). In FIG. 10, (C) illustrates an example of the executable apparatus list screen displayed on the operation unit 1600 by the process of step S121. Thereafter, the core-2 1212 starts a function having a high degree of association to the function A, with preference over other functions (step S122).

[Registering Coordinating Destination]

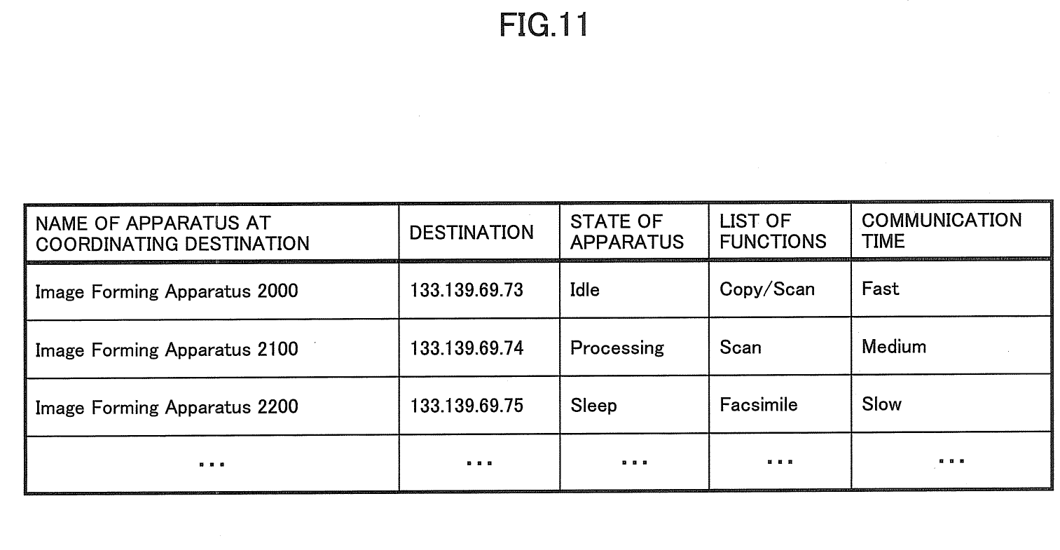

FIG. 11 is a diagram illustrating an example of the apparatus coordinating information 6010 related to other image forming apparatuses (at the coordinating destination) coordinated with the image forming apparatus 1000. For example, the apparatus coordinating information 6010 may include the name of the image forming apparatus at the coordinating destination, the destination (or IP address), the state of the apparatus, a list of functions that may be coordinated, the communication time, and the like. The image forming apparatus at the coordinating destination may be set arbitrarily by the user, for example. The format of the destination is not limited to a particular format, and may be set in IPv6, and may include information required for the communication, such as a sub-net mask or DNS (Domain Name System) server address, a default gateway, and the like. The state of the apparatus may be categorized into three types, namely, idle, processing, and sleep, for example, in order to enable easy recognition of the state of the apparatus. The idle state may indicate that the apparatus may be used immediately, the processing state may indicate that the apparatus is usable but the processing speed may be slow, and the sleep state may indicate that the apparatus is not usable because the power is OFF or the apparatus is in the dormant state. The list of the functions that may be coordinated may indicate the functions that are remotely usable from the image forming apparatus 1000. The communication time may be computed based on a communication time required when making the performance exchange that will be described later, for example, and may include information evaluating the communication time of the image forming apparatus 1000 in three stages, namely, fast, medium, and slow. The apparatus coordinating information 6010 may be displayed by switching the screen by a user operation, when the screen illustrated in (B) of FIG. 8 or (B) of FIG. 10, for example, is displayed on the operation unit 1600. In addition, the apparatus coordinating information 6010 may also be used as the information referred by the core-1 1211 when the core-1 1211 displays the executable apparatus list screen on the operation unit 1600.

[Evaluation of Degree of Association]

As described above, the core-2 1212 may start the function having the high degree of association to the function selected by the user, with preference over other functions. The core-2 1212 may learn the decree of association of each function by counting the number of times each function of the image forming apparatus 1000 is continuously used, for each user, and save the learned degree of association as a part of the preferred start information 6020.

FIG. 12 is a diagram schematically illustrating results of learning the degree of association of functions. In FIG. 12, the degree of association may indicate the number of times a situation “after a certain function is used, the next function is used within a predetermined time” occurs. The core-2 1212 may store, in the HDD 1500 or the like, the information illustrated in FIG. 12 in a tree structure using pointers, for example, so that each node (function) holds data contents (function name) indicating itself, and a node name of a branching destination (function name at a tip end of an arrow in FIG. 12). Accordingly, compared to a case in which the learned results are saved in a table data format, for example, the data size may be reduced. The functions illustrated in FIG. 12 may include, in addition to the copy, scan, print, and facsimile functions, functions such as changing paper size, PDF (Portable Document Format) conversion, OCR (Optical Character Reader) process, processing into black-and-white, producing paper output, saving file, and sending mail, for example.

[Case in which user does not Select Function]

In a case in which the loading of the UI and communication application 4000 by the core-1 1211 is completed and the user request accepting screen is displayed on the operation unit 1600, but the user does not select a function, the core-2 1212 may determine a program starting order based on the utilization frequency and the like of the function for each user.

[Performance Exchange]

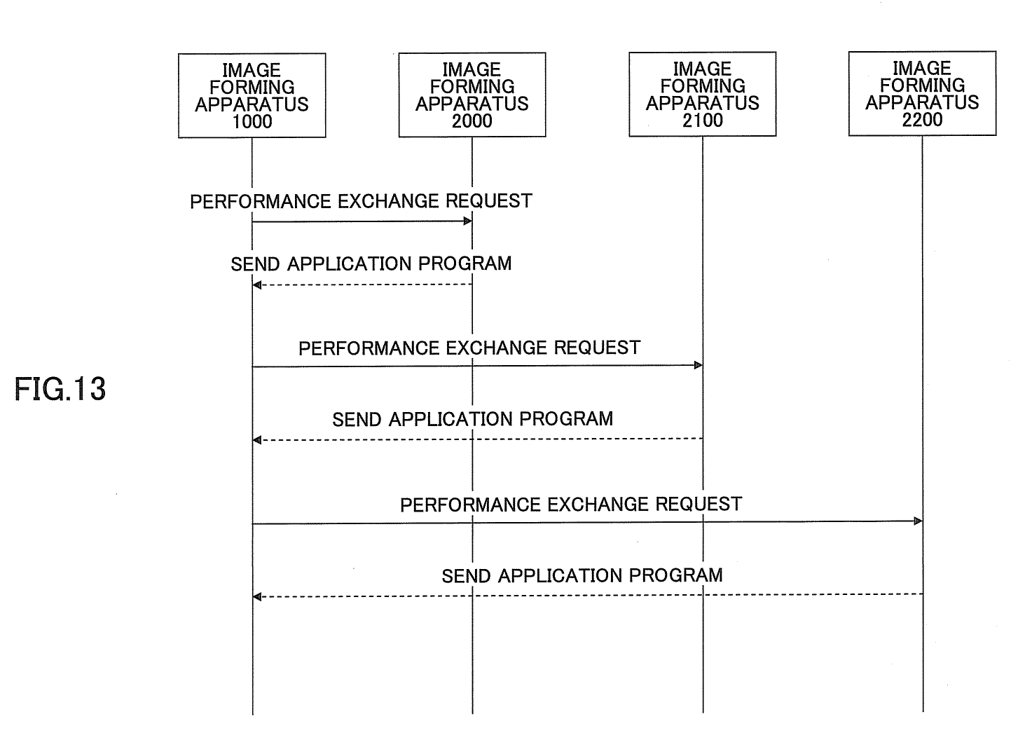

The image forming apparatus 1000 in this embodiment may exchange functions, give functions, and receive functions, with other image forming apparatuses. FIG. 13 is a sequence diagram for explaining an example of a function exchange of the image forming apparatus 1000 with the other image forming apparatuses 2000, 2100, and 2200. The performance exchange may be performed when both apparatuses are in the idle state. As illustrated in FIG. 13, when a performance exchange request is sent from the image forming apparatus 1000 to the other image forming apparatuses 2000, 2100, and 2200, the other image forming apparatuses 2000, 2100, and 2200 may send an application program to the image forming apparatus 1000, for example, in order to transfer or give the function of the other image forming apparatuses 2000, 2100, and 2200 to the image forming apparatus 1000.

[Conclusion]

According to the SoC 1200 of the image forming apparatus 1000 in this embodiment, after starting the UI and communication application 4000 for making the operation unit 1600 function as the user interface, at the time of starting the image forming apparatus 1000, that is, at the time of starting the SoC 1200, the program for executing the function selected by the user from the operation unit 1600 may be started with preference over programs for executing other functions. For this reason, the preferred start of the function desired by the user may be realized, in order to improve the utilization ease or convenience to the user.

In addition, because the core-1 1211 starts the UI and communication application 4000 and the core-2 1212 starts the program for executing the function selected by the user from the operation unit 1600, a distributed processing may be realized, in order to reduce the start time.

Moreover, after the core-2 1212 starts the program with preference, the function of the program started with preference and the program for executing the function having a high degree of association are started with preference in succession to the program started by the core-2 1212 with preference. Accordingly, when the user wishes to continuously use a plurality of functions, these functions may be started with preference in order to further reduce the wait time of the user.

Furthermore, the user may be provided with information related to image forming apparatuses other than the image forming apparatus 1000 and having the function to communicate with other image forming apparatuses and capable of executing the function selected by the user from the operation unit 1600. Hence, the user may judge whether to wait until the selected function is started in the image forming apparatus 1000, or to make the other image forming apparatuses perform the function as a substitute. In addition, because the operating state of the other image forming apparatuses may be acquired and provided to the user, the user may use the operating state as a criterion for judging whether the other image forming apparatuses are to perform the function as the substitute.

The function may be exchanged, given, received, and the like between the image forming apparatus 1000 and the other image forming apparatuses. As a result, a free functional arrangement may be realized in a system formed by a group of image forming apparatuses.

In the described embodiment, the SoC 1200 may form an example of a control apparatus. This SoC 1200 is formed by a multi-core processor in the example described above, however, this SoC 1200 may be formed by a multiprocessor provided with a main memory for each processor.

Further, the present invention is not limited to these embodiments, but various variations and modifications may be made without departing from the scope of the present invention.

What is claimed is:

1. A control apparatus comprising:
a processor configured to execute one or more programs in order to control a control target; and
an accepting unit configured to accept a user input,
wherein the processor starts a first program to cause the accepting unit to function at a time of starting the control apparatus, and thereafter starts a second program for executing a function selected by the user input accepted by the accepting unit, amongst a plurality of functions executable by the control target, with preference over programs for executing other functions.

2. The control apparatus as claimed in claim 1, wherein
the processor comprises a first processor and a second processor,
the first processor executes the first program to cause the accepting unit to function, and
the second processor executes the second program to cause the control target to execute the function selected by the user input accepted by the accepting unit.

3. The control apparatus as claimed in claim 1, wherein the processor, at the time of starting the control apparatus, starts a program having a high degree of association to the second program started with preference over the other programs having a degree of association lower than the high degree of association, based on a degree of association related to the starting of the first program.

4. The control apparatus as claimed in claim 3, wherein the processor learns the degree of association related to the starting of the first program and stores the learned degree of association in a storage unit, and starts the program having the high degree of association to the second program started with preference over the other programs having the degree of association lower than the high degree of association, based on the degree of association related to the starting of the first program stored in the storage unit.

5. The control apparatus as claimed in claim 2, wherein the first processor includes a function to communicate with another control apparatus that is configured to control another control target other than the control target, and after starting the first program to cause the accepting unit to function at the time of starting the control apparatus, the first processor provides a user with information related to the other control apparatus capable of executing the function selected by the user input accepted by the accepting unit.

6. The control apparatus as claimed in claim 5, wherein the first processor acquires an operating state of the other control target from the other control target, and provides the user with a list of other control targets capable of executing the function selected by the user input accepted by the accepting unit, together with the operating state.

7. The control apparatus as claimed in claim 1, wherein
the processor includes a function to communicate with another control apparatus that is configured to control another control target other than the control target, and
an arrangement of control functions of the control target is changeable between the other control apparatus, by sending and receiving programs between the control apparatus and the other control apparatus.

8. A method of starting a control apparatus that includes a processor configured to execute one or more programs and an accepting unit configured to accept a user input, and the processor executes a program to control a control target, the processor performing a process comprising:
starting a first program to cause the accepting unit to function at a time of starting the control apparatus; and
after starting the first program, starting a second program for executing a function selected by the user input accepted by the accepting unit, amongst a plurality of functions executable by the control target, with preference over programs for executing other functions.

9. The method as claimed in claim 8, wherein
the processor comprises a first processor and a second processor,
the first processor performs a process comprising:
executing the first program to cause the accepting unit to function, and
the second processor performs a process comprising:
executing the second program to cause the control target to execute the function selected by the user input accepted by the accepting unit.

10. The method as claimed in claim 8, wherein the process further comprises:
at the time of starting the control apparatus, starting a program having a high degree of association to the second program started with preference over the other programs having a degree of association lower than the high degree of association, based on a degree of association related to the starting of the first program.

11. The method as claimed in claim 10, wherein the process further comprises:
learning the degree of association related to the starting of the first program and storing the learned degree of association in a storage unit; and
starting the program having the high degree of association to the second program started with preference over the other programs having the degree of association lower than the high degree of association, based on the degree of association related to the starting of the first program stored in the storage unit.

12. The method as claimed in claim 9, wherein the process performed by the first processor further comprises:
communicating with another control apparatus that is configured to control another control target other than the control target; and
after starting the first program to cause the accepting unit to function at the time of starting the control apparatus, providing a user with information related to the other control apparatus capable of executing the function selected by the user input accepted by the accepting unit.

13. The method as claimed in claim 12, wherein the process performed by the first processor further comprises:
acquiring an operating state of the other control target from the other control target; and
providing the user with a list of other control targets capable of executing the function selected by the user input accepted by the accepting unit, together with the operating state.

14. The method as claimed in claim 8, wherein the process further comprises:
communicating with another control apparatus that is configured to control another control target other than the control target,
wherein an arrangement of control functions of the control target is changeable between the other control apparatus, by sending and receiving programs between the control apparatus and the other control apparatus.
